(19) United States
(12) Patent Application Publication
(10) Pub. No.: US 2017/0257161 A1
(43) Pub. Date: Sep. 7, 2017

(54) DIGITAL RADIO TRANSMITTER

(71) Applicant: SII Semiconductor Corporation, Chiba-shi (JP)

(72) Inventors: Hiroyuki YONETANI, Chiba-shi (JP); Kazuaki HORI, Chiba-shi (JP); Toshiyuki TANAKA, Chiba-shi (JP); Biao SHEN, Chiba-shi (JP)

(21) Appl. No.: 15/448,037

(22) Filed: Mar. 2, 2017

(30) Foreign Application Priority Data
Mar. 7, 2016 (JP) 2016-043653

(51) Int. Cl. H04B 7/24; H04W 52/52

(52) U.S. Cl. CPC H04B 7/24; H04W 52/52

(57) ABSTRACT

There is provided a digital radio transmitter capable of meeting a legal standard even if unwanted emissions resulting from a switching frequency of a switching power supply occur in transmission waves. The digital radio transmitter includes: a switching power supply that determines a switching frequency by a synchronization signal of an oscillator; a data readout/transfer circuit that determines a transfer timing frequency of baseband data based on the synchronization signal of the oscillator; and a power amplifier using, as a VCC power source, voltage output from the switching power supply.

### RELATED APPLICATIONS

This application claims priority under 35 U.S.C. §119 to Japanese Patent Application No. 2016-043653 filed on Mar. 7, 2016, the entire content of which is hereby incorporated by reference.

### BACKGROUND OF THE INVENTION

Field of the Invention

The present invention relates to a radio transmitter in the field of digital radio communication.

Background Art

As personal digital appliances, such as personal computers and smartphones (hereinafter abbreviated as PCs), become widespread, the occasion to connect input/output devices such as a mouse and a head set to PCs using wireless standards such as the Bluetooth is increasing. Since the input/output devices are battery-driven devices, a power-efficient switching system is preferably used as the power supply.

FIG. 6 illustrates an example of a digital radio transmitter using a conventional step-down switching power supply. Data to be transmitted are loaded into a data readout/transfer circuit 5, subjected to digital baseband modulation such as ASK or FSK at a first-order modulator 6, and input to a frequency converter 9 via a DAC (DA converter) 7 and an LPF (lowpass filter) 8. A frequency-converted signal is amplified at a power amplifier 10 up to a predetermined strength, and output as transmission waves via a BPF (bandpass filter) 11.

The VCC power supply of the power amplifier 10 supplies power from a switching power supply 15 through the LPF 4. In general, since the power consumption of the power amplifier 10 is high, the switching power supply 15 and the power amplifier 10 are often wired to each other independently to avoid the influence on the other circuit blocks. Though not illustrated here, power is supplied to the circuit blocks other than the power amplifier 10 by wiring different from power wiring 16 to the power amplifier 10.

In the case of using the typical step-down switching power supply 15 as the VCC power supply of the power amplifier 10, some switching frequencies of harmonics in the switching power supply may be converted into a carrier-frequency band of the digital radio transmitter, resulting in unwanted emissions that exceed the level of leakage power defined in the wireless standard.

FIG. 7 illustrates an example of a conventional transmission wave spectrum.

This spectrum illustrates an example of hopping to the highest frequency in radio facilities for identifying mobile objects in a band of 2.4 GHz for specified low-power radio stations using a frequency hopping system, where a main spectral component 21 of transmit data exists at the center, and unwanted emissions 22 of AC components of the VCC power supply resulting from the switching frequency exist both ends thereof. The center frequency is 2480 MHz, and as illustrated in FIG. 7, an allowable antennal power 23 is 3 mW at frequencies of 2483.5 MHz or less, or 25 μW at frequencies exceeding 2483.5 MHz. In the example of FIG. 7, the unwanted emissions on the high frequency side exceed the allowable antenna power 23. To solve such a problem and remove the ripple noise of the power supply of the digital radio transmitter with a switching regulator incorporated therein, there is disclosed a case where an expensive ripple filter is required to be added onto a power supply line (for example, Patent Document 1).

[Patent Document 1] Japanese Patent Application Laid-Open No. 2003-133972

### SUMMARY OF THE INVENTION

When the conventional switching power supply is used as-is for the VCC power supply of the power amplifier, there is a problem that big unwanted emissions appear in the transmission wave spectrum and hence it cannot meet the wireless standard. As a countermeasure for the problem, it is necessary to add an expensive filter onto the power-supply line.

In order to solve the conventional problem, a digital radio transmitter of the present invention is configured as follows:

The digital radio transmitter includes: a switching power supply that determines a switching frequency by a synchronization signal of an oscillator; a data readout/transfer circuit that determines a transfer timing frequency of baseband data based on the synchronization signal of the oscillator; and a power amplifier using, as a VCC power source, voltage output from the switching power supply.

Alternatively, another configuration is such that a frequency converter/adder is provided to add, to the input side of the power amplifier, components whose phase is opposite to the time waveforms of unwanted emissions included in transmission waves.

According to the digital radio transmitter of the present invention, unwanted emissions of transmission waves can be reduced without enhancing a power supply filter or a transmission filter. Further, the digital radio transmitter can be made to conform to a regal standard therefor by setting a dividing ratio or adjusting the phase shift amount without any design change.

### BRIEF DESCRIPTION OF THE DRAWINGS

FIG. 1 is a schematic diagram of an example of a digital radio transmitter according to a first embodiment of the present invention.

FIG. 2 is a graph of an example of a transmission wave spectrum according to the first embodiment of the present invention.

FIG. 3 is a schematic diagram of an example of a digital radio transmitter according to a second embodiment of the present invention.

FIG. 4 is a schematic diagram of another example of the digital radio transmitter according to the second embodiment of the present invention.

FIG. 5 is a graph of another example of the transmission wave spectrum according to the second embodiment of the present invention.

FIG. 6 is a schematic diagram of an example of a conventional digital radio transmitter.

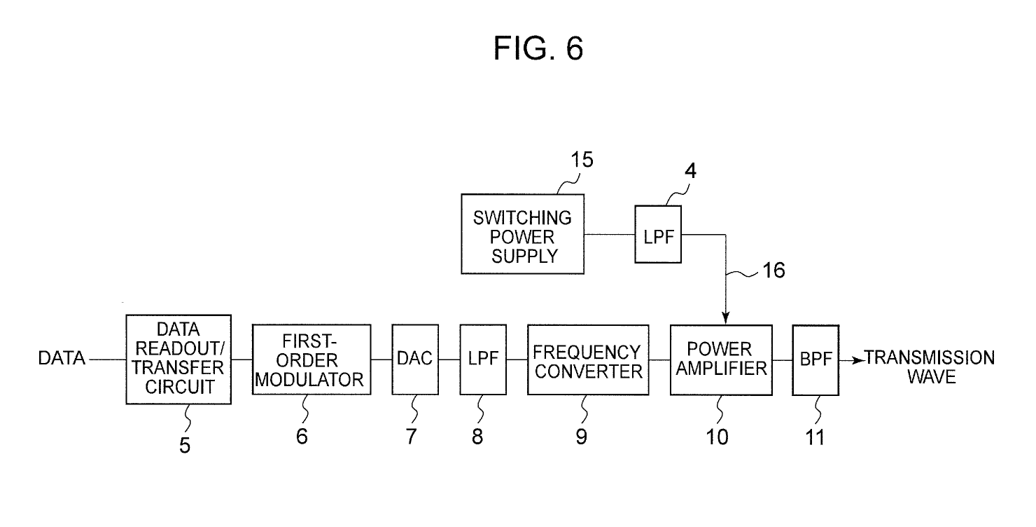

FIG. 7 is a graph of an example of a conventional transmission wave spectrum.

### DETAILED DESCRIPTION OF THE PREFERRED EMBODIMENTS

### First Embodiment

A first embodiment of the present invention will be described below with reference to the accompanying drawings.

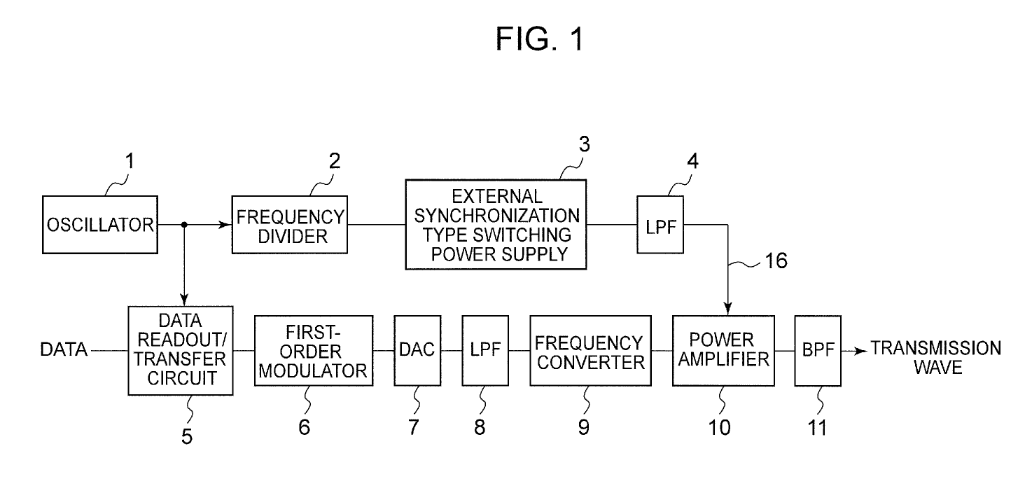

FIG. 1 is a schematic diagram of a digital radio transmitter according to the first embodiment. An oscillator 1 outputs a frequency reference clock to a frequency divider 2 and a data readout/transfer circuit 5. The frequency divider 2 divides the frequency reference clock by a predetermined dividing ratio to obtain a synchronization signal to an external synchronization type switching power supply 3. DC power generated by the external synchronization type switching power supply 3 is supplied as a VCC power source to a power amplifier 10 via an LPF (lowpass filter) 4. Here, the oscillator 1 is specifically an oscillator using a quartz crystal unit or a frequency-stabilized oscillator such as TCXO.

The data readout/transfer circuit 5 reads out data at the rising or falling timing of the frequency reference clock as output of the oscillator 1, and transfers the read data to a downstream first-order modulator 6. The first-order modulator 6 assumes digital baseband modulation such as ASK, PSK, or FSK. The data readout/transfer may be performed at the rising or falling timing of a clock obtained by dividing the frequency reference clock, rather than that performed in the cycle of the frequency reference clock as the output of the oscillator 1. Since data processing such as interleaving and encoding, for which the data are not required to have a synchronization relationship to the frequency reference clock as the output of the oscillator 1, is not essential, the description thereof will be omitted. The output of the first-order modulator 6 is input to a frequency converter 9 via a DAC (DA converter) 7 and an LPF (lowpass filter) 8. At the frequency converter 9, second-order modulation such as frequency spread or frequency hopping is performed. Even when the frequency converter 9 is a simple up-converter or in a system for performing conversion processing on plural IFs (intermediate frequencies), the essence of the present invention does not change.

In the meantime, the oscillator 1 may not be necessarily used as the clock source for a local signal required for frequency conversion. In other words, the carrier of the transmission waves is not necessarily synchronized with the phase of the data. The phase of the baseband data signal has only to be aligned with the output of the oscillator 1. The output of the frequency converter 9 is input to the power amplifier 10 to amplify the transmission waves up to a level of power necessary for transmission. The output of the power amplifier 10 is output as transmission waves to an antenna element or the like via a BPF (bandpass filter) 11.

As described above, a data transfer system from the data readout/transfer circuit 5 to the frequency converter 9 is synchronized with a power supply system from the oscillator 1 to the LPF 4. Further, the cycles of both systems are in an integer ratio. Although the number of divisions of the frequency divider 2 may be predetermined, it is desired that the dividing ratio should be variable so that the transmission waves obtained can be regulated while monitoring the transmission waves.

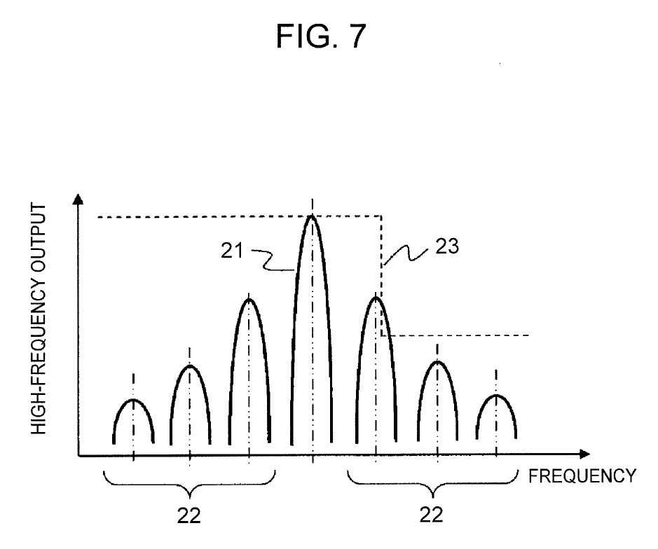

Here, the frequency of the synchronization signal can be changed by changing the dividing ratio of the frequency divider 2 in FIG. 1. For example, in a case where the switching frequency is 3 MHz in FIG. 7, if the frequency of the synchronization signal in FIG. 1 is also 3 MHz, the transmission waves will be like those in FIG. 7.

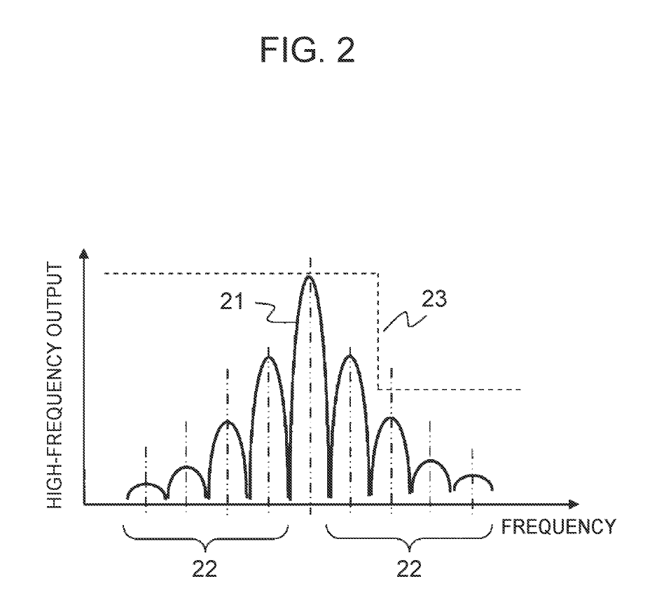

FIG. 2 illustrates an example of the spectrum of transmission waves of the digital radio transmitter according to the first embodiment.

This spectrum illustrates an example of hopping to the highest frequency in radio facilities for identifying mobile objects in a band of 2.4 GHz for specified low-power radio stations using a frequency hopping system, where a main spectral component 21 of transmit data exists at the center, and unwanted emissions 22 of AC components of the VCC power supply resulting from the switching frequency exist both ends thereof. The center frequency is 2480 MHz, and an allowable antennal power 23 is 3 mW at frequencies of 2483.5 MHz or less, or 25 μW at frequencies exceeding 2483.5 MHz.

If the dividing ratio of the frequency divider 2 is doubled to set the frequency of the synchronization signal to 1.5 MHz, since low-order unwanted emissions relatively high in intensity among the unwanted emissions 22 as in FIG. 2 come between 2480 MHz and 2483.5 MHz in a relatively relaxed leakage-power standard, the transmission waves can be complied with the standard.

This is a result of taking measures without changing the LPF 4 (power supply filter, ripple filter) illustrated in FIG. 1 in the situation of the transmission waves in FIG. 7, meaning that the specifications of the LPF 4 can be relaxed if the number of divisions of the frequency divider 2 is predetermined in consideration of the frequency band of unwanted emissions. The same applies to a case where it is difficult to comply with the standard for adjacent channel leakage power. If the standard to be relaxed as the unwanted emissions 22 spread outward from the required frequency band, the profile of the unwanted emissions may be set outward.

Further, the digital radio transmitter of the embodiment features that the frequency reference clock of the data readout/transfer circuit 5 is synchronized with the switching frequency of the switching power supply 3. Specifically, the timing when the baseband data signal is changed is synchronized with the AC components resulting from the switching frequency included in the VCC power source of the power amplifier 10. Therefore, cyclical changes in the intensity of the transmission wave spectrum including unwanted emissions are suppressed and stabilized. In other words, random noise caused by the VCC power source becomes coherent noise synchronized with the VCC power source. This makes clear the countermeasure against noise and the confirmation of the effect of the countermeasure.

### Second Embodiment

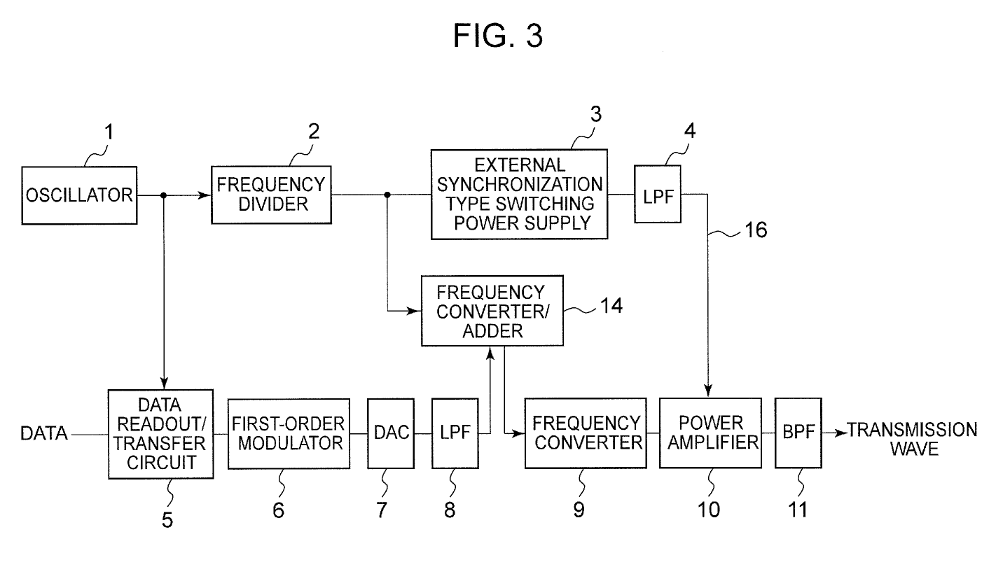

FIG. 3 is a schematic diagram of a digital radio transmitter according to a second embodiment of the present invention. The digital radio transmitter according to the embodiment further includes a frequency converter/adder 14 in addition to the configuration of the first embodiment.

At the frequency converter/adder 14, the baseband data signal input to the frequency converter 9 is regulated upstream of the frequency converter 9. Specifically, a synchronization signal, whose phase shift amount and amplitude are so adjusted that unwanted emissions generated by the AC components of the VCC power source can be canceled at the power amplifier 10, is added to the baseband data signal.

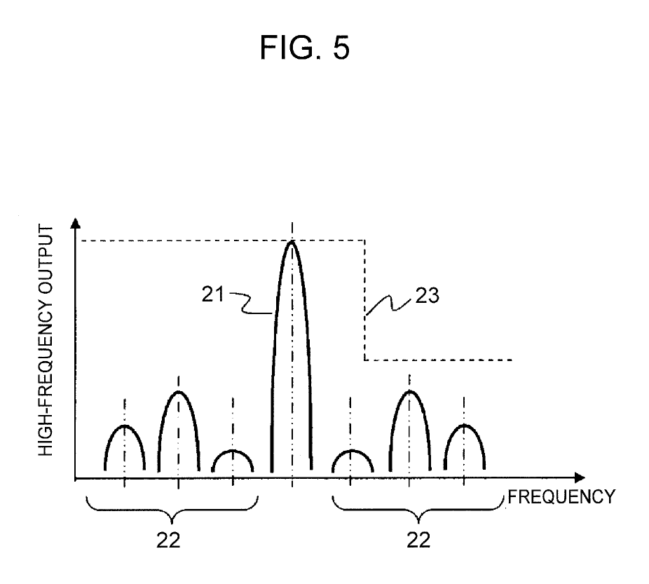

According to this configuration, a high-frequency output spectrum corresponding to the switching frequency of the switching power supply 3 (=the frequency of the synchronization signal) can be obtained as illustrated in FIG. 5, where most-influential, low-order unwanted emissions can be suppressed.

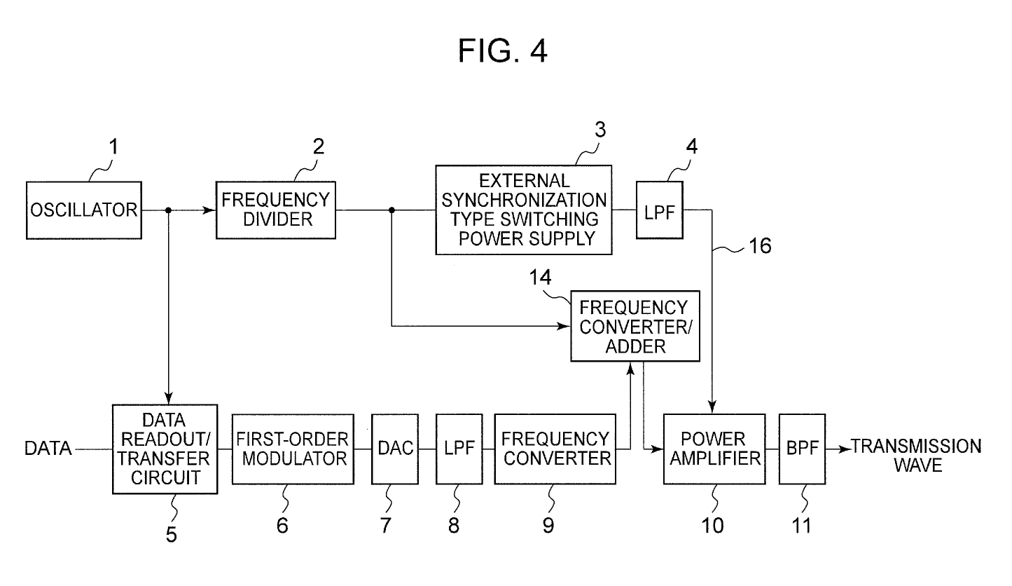

FIG. 4 is a schematic diagram of another example of the digital radio transmitter according to the second embodiment of the present invention. In the circuit configuration of FIG. 4, signal processing like that in FIG. 3 is performed in a high-frequency band downstream of the frequency converter 9.

According to this configuration, most-influential, low-order unwanted emissions can be suppressed. In other words, transmission waves that cannot comply with a legal standard due to the unwanted emissions 22 resulting from the synchronization signal as illustrated in FIG. 7 can be transmission waves that comply with the legal standard as illustrated in FIG. 5 without replacing the LPF 4 or the BPF 11 by an expensive, sophisticated filter.

What is claimed is:

1. A digital radio transmitter comprising:
an oscillator;
a switching power supply that deter mines a switching frequency by a synchronization signal of the oscillator;
a data readout/transfer circuit that determines a transfer timing frequency of baseband data based on the synchronization signal of the oscillator; and
a power amplifier using, as a VCC power source, voltage output from the switching power supply.

2. The digital radio transmitter according to claim 1, wherein
a frequency divider is provided between the oscillator and the switching power supply, and
the transfer timing frequency of the baseband data and the switching frequency are frequencies in an integer ratio.

3. The digital radio transmitter according to claim 1, wherein
a frequency converter/adder is provided between the data readout/transfer circuit and the power amplifier, and
based on the synchronization signal and a baseband data signal, the frequency converter/adder creates and adds a signal whose phase is opposite in a frequency band identical to that of an unwanted emission.

4. The digital radio transmitter according to claim 2, wherein
a frequency converter/adder is provided between the data readout/transfer circuit and the power amplifier, and
based on the synchronization signal and a baseband data signal, the frequency converter/adder creates and adds a signal whose phase is opposite in a frequency band identical to that of an unwanted emission.
